(19) United States
(12) Patent Application Publication
(10) Pub. No.: US 2013/0070327 A1
(43) Pub. Date: Mar. 21, 2013

(54) MULTI-LAYER MAGNETO-OPTIC STRUCTURE

(71) Applicant: Roger Dunstan Jeffery, City Beach (AU)

(72) Inventor: Roger Dunstan Jeffery, City Beach (AU)

(73) Assignee: PANORAMA SYNERGY LTD., Balcatta, Western Australia (AU)

(21) Appl. No.: 13/697,137

(22) PCT Filed: May 6, 2011
(86) PCT No.: PCT/AU2011/000524

§ 371 Date: Nov. 9, 2012

(30) Foreign Application Priority Data
May 11, 2010 (AU) 2010902015
May 6, 2011 (AU) PCT/AU2011/000524

(51) Int. Cl. G02F 1/09; B05D 5/06

(52) U.S. Cl. CPC G02F 1/09; B05D 5/061
USPC 359/280; 427/130

(57) ABSTRACT

A structure (10) for rotating a plane of polarization of a polarized visible light signal, including a lower mirror (13) bonded to a top of a substrate (11) with a first bonding layer (12a), a magneto-optic layer (14) disposed on a top of the lower mirror (13), and an upper mirror (15) disposed on a top of the magneto-optic layer (14); wherein when the structure (10) is annealed the first bonding layer (12a) aids adhesion of the lower mirror (13) to the substrate (11).

### FIELD OF THE INVENTION

This invention relates to a multi-layer magneto-optic structure and in particular a structure utilising the Kerr Effect to produce an enhanced polarization rotation of a polarized visible light source.

### BACKGROUND TO THE INVENTION

Planar structures utilising the Kerr Effect have been explored for increasing a polarization rotation of polarized visible light to enhance the magneto-optic effect for recording purposes. For example applications of such structures include use in Digital Versatile Disc (DVD) and Compact Disc (CD) recorders. One such example is described in the paper “Giant Polar MO Kerr effect in high reflectance multilayer enhanced structures”, R Atkinson and M ONeill, Journal of Magnetism and Magnetic Materials 155 (1996) 361-363. The structure comprises a planar magneto-optic layer disposed above a first planar mirror. A spacer is positioned on top of the magneto-optic layer before a second planar mirror is positioned on top of the spacer. Each mirror is formed from alternating layers of high and low refractive index dielectric materials. Zinc Sulphide (ZnS) forms the high refractive index material and Magnesium Fluoride (MgF₂) forms the low refractive index material.

A similar structure is disclosed in U.S. Pat. No. 6,590,694 which describes an isolator for use at 1500 nm. A metal reflective film, which is used as a highly reflective surface, is deposited onto a substrate followed by a first mirror, a magneto-optic film and a second mirror formed on top of the magneto-optic film without requiring a spacer.

In order to manufacture the structures of the above paper and the above patent, once each layer has been disposed, the whole structure is heated to approximately 650° C. in order to crystallize the magnetic-optic layer. However, the heating process can cause delamination of the mirror layers, cause absorbing layers to form in the mirrors, and cause the mirrors to crack. The delamination is due to differences in thermal expansion between the different dielectric mirror layers, crystallization of the mirror material, and/or poor bonding between the magneto-optic layer, the spacer and the mirrors. Furthermore, the absorbing layers are attributed to diffusion of elements at the boundaries of the mirror materials causing a reduction in optical performance, for example a reduction in the optical power reflected.

A further problem is that the prior art structures are complex to manufacture. In the case of the structure described in the above paper careful tuning of the additional spacer layer is required. The structure disclosed in the above patent requires a metallic film deposition which has a significantly different thermal expansion compared to the dielectric mirror materials causing the problems discussed above. Furthermore, the structure described in the patent is based on the Faraday effect and has been designed for use at wavelengths of around 1550 nm, i.e. infra-red frequencies. Thus the structure described in the patent is unsuitable for use at visible wavelengths where the metallic mirror has insufficient reflectance and is therefore unsuitable for use in various applications such as cinema projection.

U.S. Pat. No. 4,596,740 to Tsukane, describes a method of improving a bondability of a polymer layer to a plastic substrate. However the bonding of the polymer to the plastic substrate is performed by sputtering followed by curing in an oven at approximately 70° C., and therefore does not suffer from the problems associated with annealing. If the structure of Tsukane was annealed the substrate would melt.

### OBJECT OF THE INVENTION

It is an object of the invention to overcome or alleviate one or more of the above disadvantages and/or to provide the market with a useful or commercial choice.

### SUMMARY OF THE INVENTION

In one form, although it need not be the only or indeed the broadest form, the invention resides in a structure for rotating a plane of polarization of a polarized visible light signal including:

a lower mirror bonded to a top of a substrate with a first bonding layer;

a magneto-optic layer disposed on a top of the lower mirror; and

an upper mirror disposed on a top of the magneto-optic layer; wherein when the structure is annealed the first bonding layer aids adhesion of the lower mirror to the substrate.

Preferably, the lower mirror and the upper mirror are formed from a number of layers of a high refractive index layer adjoining a low refractive index layer.

Preferably, the high refractive index layer and the low refractive index layer are transparent dielectric materials for use at visible wavelengths.

Suitably, the thickness of the high refractive index layer is λ/4n and the thickness of the low refractive index material is λ/4n,

where:

n is the refractive index of the dielectric layer; and

λ is the wavelength of operation.

Optionally, the magneto-optic layer is bonded to the top of the lower mirror with a second bonding layer wherein the second bonding layer prevents an absorbing layer from forming between the lower mirror and the magneto-optic layer.

Optionally, the upper mirror is bonded to the top of the magneto-optic layer with a second bonding layer wherein the second bonding layer prevents an absorbing layer from forming between the upper mirror and the magneto-optic layer.

Additional third bonding layers may be provided between each low refractive index layer and each high refractive index layer used to form the lower mirror and the upper mirror. The third bonding layers prevent absorbing layers from forming due to diffusion between the high and low refractive index layers, and prevent the mirrors from cracking and delaminating when annealed.

Optionally the low refractive index layer and each bonding layer is chosen from Magnesium Oxide (MgO), Sapphire (AL₂O₃) or Silicon Dioxide (SiO₂) and the high refractive index layer is chosen from Tantalum Pentoxide (Ta₂O₅), Gallium Oxide (Ga₂O₃) or Dysprosium Oxide (Dy₂O₃) but is not limited to these materials. Ideally, the high and low refractive index layers crystallize at temperatures above 650° C. to limit dimensional changes which may cause delamination.

Suitably the magneto-optic layer material is chosen from any one of bismuth iron garnets, such as Bi₂DyFe₄GaO₁₂ or cerium iron garnets such as Ce₂DyFe₄GaO₁₂.

Preferably the thickness of the magneto-optic layer is an integral number, m, of m(λ/2n) where:

n is the refractive index of the dielectric layer; and

λ is the wavelength of operation.

Optionally, an electronic circuit is formed in or on the substrate and is protected by a layer of MgO.

In another form, the invention resides in a method of manufacturing a structure for rotating a plane of polarization of a polarized visible light signal including:

depositing a first bonding layer to a top of a substrate;

depositing a lower mirror to a top of the first bonding layer;

depositing a magneto-optic layer to a top of the lower mirror;

depositing an upper mirror to a top the magneto-optic layer; and

annealing the structure;

wherein the first bonding layer aids adhesion of the lower mirror to the substrate.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 shows a section of a multi-layer magneto-optic structure according to a first embodiment of the present invention;

FIG. 2 shows a section of a multi-layer magneto-optic structure according to a second embodiment of the present invention;

FIG. 3 shows a section of a lower mirror of the structure of FIGS. 1 and 2 according to an embodiment of the present invention;

FIG. 4 shows a section of an upper mirror of the structure of FIGS. 1 and 2 according to an embodiment of the present invention;

FIG. 5 shows a section of a lower mirror of the structure of FIGS. 1 and 2 having a third bonding layer according to an embodiment of the present invention; and

FIG. 6 shows a section of an upper mirror of the structure of FIGS. 1 and 2 having a third bonding layer according to an embodiment of the present invention.

### DETAILED DESCRIPTION OF THE INVENTION

In this specification, adjectives such as first and second, left and right, and the like may be used solely to distinguish one element or action from another element or action without necessarily requiring or implying any actual such relationship or order. Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus.

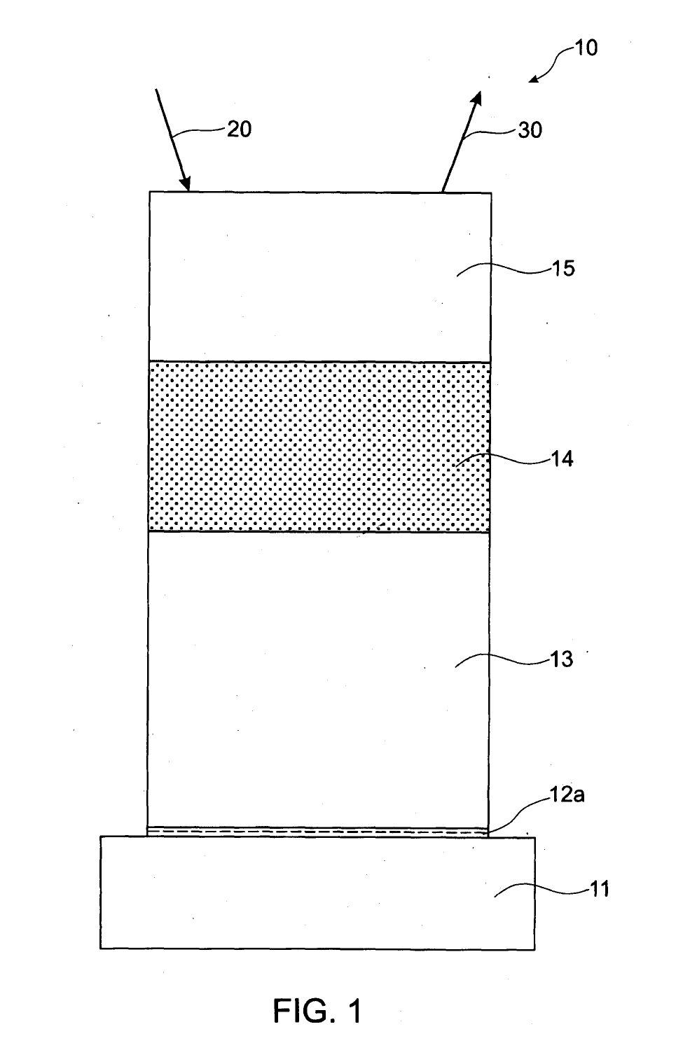

FIG. 1 shows a section of a magneto-optic structure 10 according to a first embodiment of the present invention. The structure 10 is planar and includes a substrate 11, a first bonding layer 12a, a lower mirror 13, a magneto-optic layer 14 and an upper mirror 15. The first bonding layer 12a is used to improve a bond between the substrate 11 and the lower mirror 13. Polarized light 20 enters the structure 10 and passes through the upper mirror 15 to the magneto-optic layer 14 where the polarized light 20 is rotated through a plane of polarization in the presence of a magnetic field applied to the structure 10. The polarized light 20 is reflected by the lower mirror 13 and passes through the magneto-optic layer 14 for a second time where the polarized light 20 is rotated further before output light 30 exits the structure 10. The structure 10 places the magneto-optic layer 14 in an optical cavity formed by the upper mirror 15 and the lower mirror 13. The optical cavity causes a peak in the electric field across the magneto-optic layer 14 and thereby enhances the polar Kerr effect in this layer.

Although FIG. 1 shows the polarized light 20 entering the structure 10 at an angle, it should be appreciated that the polarized light 20 may enter normally (i.e. at right angles) to the structure 10 or at any suitable angle of incidence. However, it may be advantageous to have a small angle, for example approximately 7 degrees, in order to separate the polarized light 20 from the output light 30.

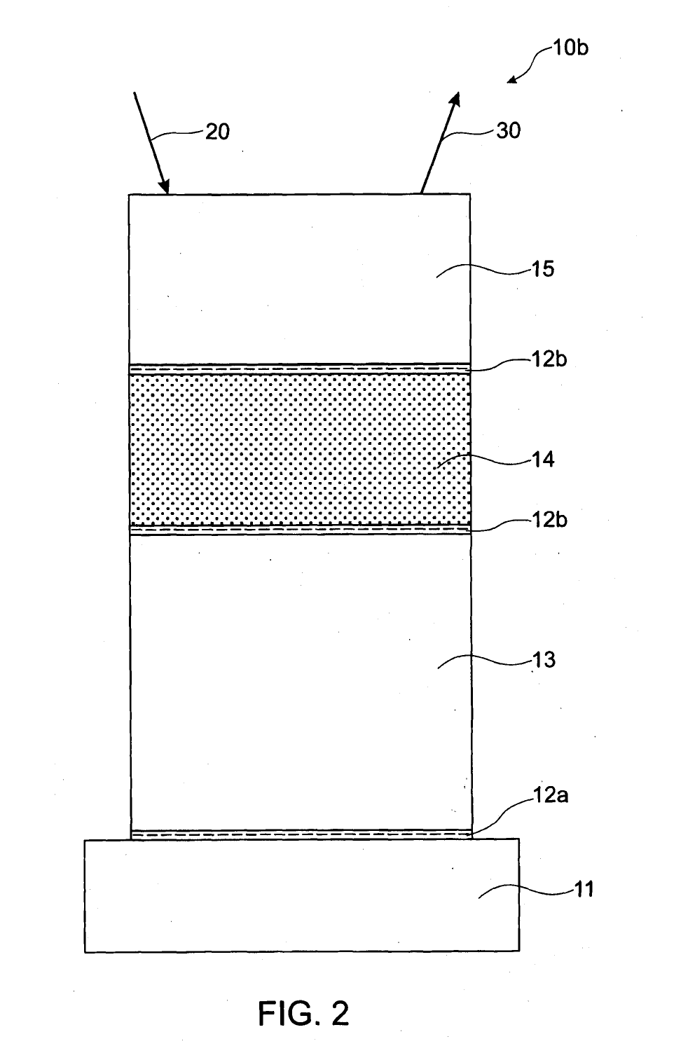

FIG. 2 shows a section of a magneto-optic structure 10b according to a second embodiment of the present invention. The structure 10b is identical to the structure 10 shown in FIG. 1 with the exception that second bonding layers 12b are used to bond the magneto-optic layer 14 to each mirror 13, 15. In addition to improving a bond between the mirrors 13, 15 and the magneto-optic layer 14, the bonding layers 12b prevent an absorbing layer forming between the mirrors 13, 15 and the magneto-optic layer 14.

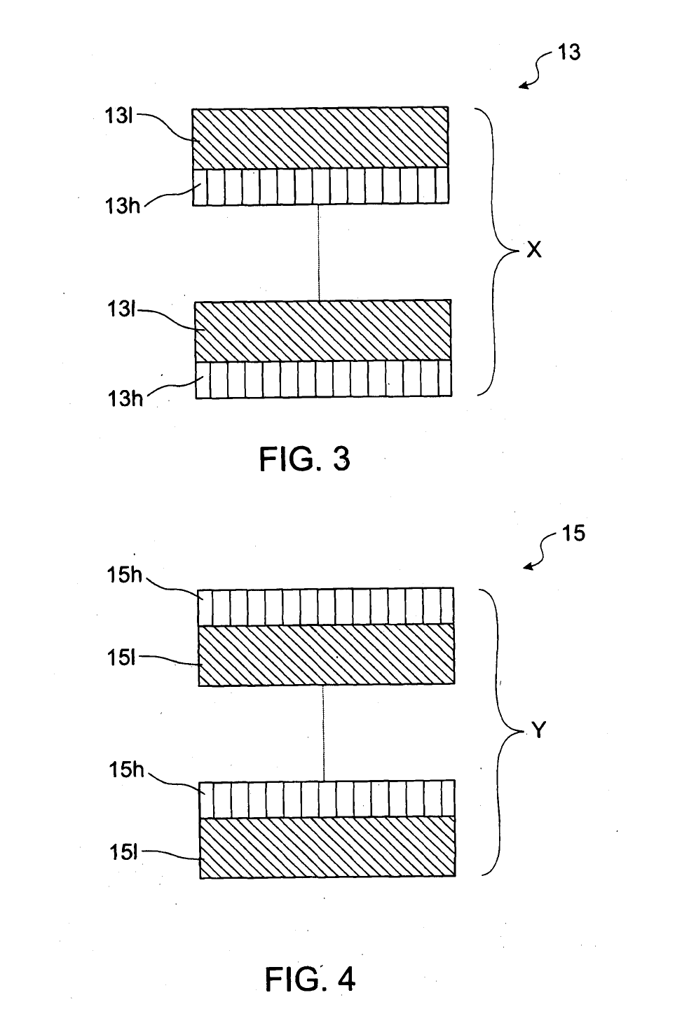

FIG. 3 shows a section of a lower mirror 13 of the structure of FIGS. 1 and 2 and FIG. 4 shows a section of an upper mirror 15 of the structure of FIGS. 1 and 2 according to an embodiment of the present invention. Each mirror 13, 15 is formed from a number of repetitions X, Y of a high refractive index layer 13h, 15h adjoining a low refractive index layer 13l, 15l. The number of repetitions X that forms the lower mirror 13 is greater than the number of repetitions Y that form the upper mirror 15. The thickness of each high refractive index layer 13h, 15h is λ/4n and the thickness of each low refractive index layer 13l, 15l is also λ/4n

where:

n is the refractive index of the dielectric layer material; and

λ is the wavelength of visible light of operation, for example, red, green or blue.

The materials used for manufacturing the mirrors 13, 15 are preferably dielectric and preferably crystallize at temperatures higher than temperatures required to crystallize the magneto-optic layer 14. In a preferred embodiment, the material used for the low refractive index layer 13l, 15l is chosen from Magnesium Oxide (MgO), Sapphire (Al₂O₃) or Silicon Dioxide (SiO₂). MgO and AL₂O₃ are most preferable as they have strong bonds with dissimilar materials.

Preferably, the high refractive index layer 13h, 15h is chosen from Tantalum Pentoxide (Ta₂O₅), Gallium Oxide (Ga₂O₃) or Dysprosium Oxide (Dy₂O₃) however Dy₂O₃ is the preferred material as it crystallizes at temperatures over 1000 C.

The magneto-optic layer 14 is preferably made of bismuth iron garnets, such as Bi₂DyFe₄GaO₁₂ or cerium iron garnets such as Ce₂DyFe₄GaO₁₂. The thickness of the magneto-optic layer 14 depends on a wavelength of operation and is an integral number, m, of half wavelengths of the wavelength of operation. Thus the thickness is m(λ/2n),

where:

m=integer (1, 2, 3 . . . z) determined to provide the required Kerr rotation;

n is the refractive index of the magneto-optic layer; and

λ is the wavelength of operation.

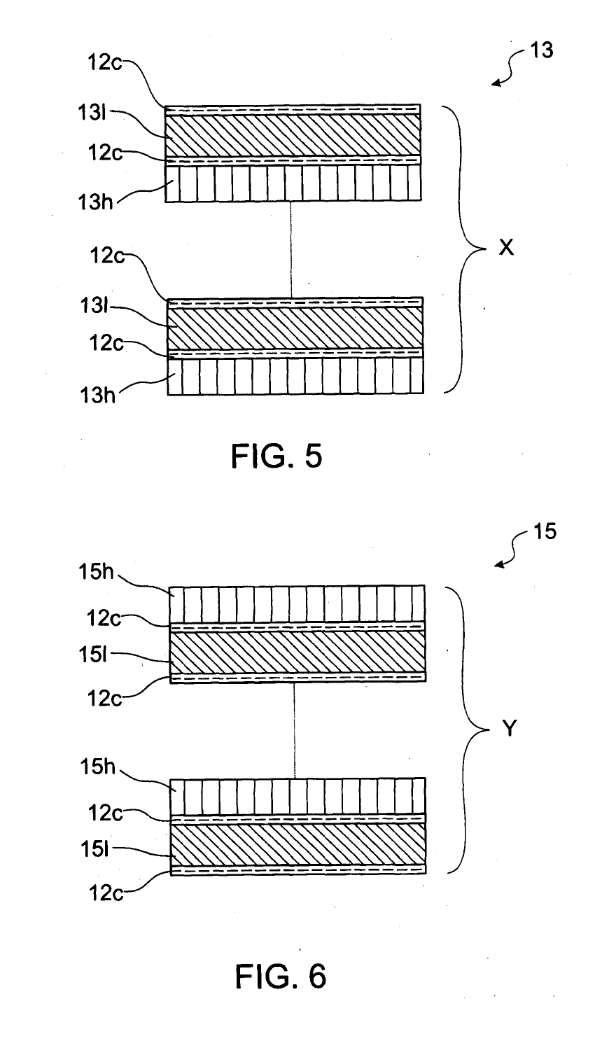

An additional third bonding layer 12c may be used between each high refractive index layer 13h, 15h and each low refractive index layer 13l, 15l in the mirrors 13, 15 as shown in FIGS. 5 and 6. The third bonding layer 12c is used in this instance to prevent the mirrors 13, 15 from delaminating, cracking and, from absorbing layers forming between the high and low refractive index layers. The absorbing layers can be formed due to diffusion between the high refractive layers 13h, 15h and the lower refractive index layers 13l, 15l.

When second bonding layers 12b are used, the thickness of the low refractive index material 13l, 15l nearest to the magneto-optic layer 14 needs to be reduced to take into account the thickness of the second bonding layers 12b. Similarly the thickness of each low refractive index material 13l, 15l used to form the mirrors 13, 15 needs to be reduced when the third bonding layers 12c are used such that the low refractive index layer 13l, 15l plus the third bonding layer 12c is still a quarter of a wavelength thick.

Each bonding layer 12 is a lower refractive index material than each high refractive index layer 13h, 15h and may be the same low refractive index material used in the mirror 13, 15 layers. In a preferred embodiment, the bonding layer is MgO or Al₂O₃. An additional advantage of MgO is that it may shield an electronic circuit formed in or on the substrate 11 from high annealing temperatures. It should be appreciated that the bonding layers 12 may be of any suitable material that produces a strong bond between the lower mirror 13 and the substrate, between the mirrors 13, 15 and the magneto-optic layer 14, and between the high and low refractive index layers, 13h, 15h, 13l, 15l used to form the mirrors 13, 15. Furthermore it should be appreciated that different materials may be used in the first, second and third bonding layers 12a, 12b, 12c.

The structures 10, 10b are manufactured by depositing a first bonding layer 12a on a top surface of the substrate 11. This is followed by the high and low refractive index layers and, if required, third bonding layers 12c to form the lower mirror 13. The second bonding layer 12b, if required, is deposited on top of the lower mirror 13 and the magneto-optic layer 14 is deposited on top of the lower mirror 13 followed by another second bonding layer 12b (if required). The last step is to deposit the high and low refractive layers 13h, 15h, 13l, 15l and, if necessary third bonding layers 12c, to form the upper mirror 15.

Each layer is deposited using sputtering techniques such as RF Magnetron Sputtering and Reactive Ion Sputtering, however it should be appreciated that other sputtering techniques are available. It should be noted that the second bonding layer 12b is optional and in this case the mirrors 13, 15 rely on the low refractive layer 13l, 15l to bond the mirrors 13, 15 to the magneto-optic layer 14. The structure 10 is then heated to crystallize the magneto-optic layer 14.

Each bonding layer 12 promotes a mechanical bond, prevents the mirrors 13, 15 from delaminating and cracking and prevents absorbing layers from forming at an interface of the mirrors and the magneto-optic layer. Similar effects occur when a third bonding layer 12c is between the high and low refractive index layers 13h, 15h, 13l, 15l used in the mirrors 13, 15. Absorbing layers are formed due to the diffusion of material between each layer and the substrate and the use of a bonding layer 12 acts as a diffusion barrier.

In use, the structures 10, 10b are designed to operate at a required frequency, wavelength or colour. For use in cinema projection, three primary colours are required: red, green and blue. Thus the thicknesses of the layers are set according to the wavelength of the chosen colour. Nominal wavelengths of the primary colours are shown below:
Red: 632 nm
Green: 532 nm
Blue: 477 nm

An example of a structure will now be described with reference to the figures. In this example the first bonding layer 12a material is MgO and the mirrors 13, 15 are made from alternating layers of Ta₂O₅ (high refractive index layer 13h, 15h) and Al₂O₃ (low refractive index layer 13l, 15l). The thickness of the MgO layer forming the first bonding layer 12a is not important; however it is typically 15 nm. Ta₂O₅ has a nominal refractive index of 2.1 and Al₂O₃ has an nominal refractive index of 1.6 at visible wavelengths thus the thicknesses at each primary colour wavelength is calculated according to the equation:

thickness=λ/4n (Eq. 1)

where:

n=refractive index of the material; and

λ=wavelength of operation

Thus the approximate thicknesses of each high refractive layer 13h, 15h and each low refractive index layer 13l, 15l is shown in the table below:

| | Approximate | Approximate |
|---|---|---|
| Colour @ wavelength | Thickness of Ta₂O₅ | Thickness of Al₂O₃ |
| Red @ 632 nm | 75.2 nm | 98.8 nm |
| Green @ 532 nm | 63.3 nm | 83.1 nm |
| Blue @ 477 nm | 56.8 nm | 74.5 nm |

If a second layer bonding layer 12b of MgO is used then the thickness of a low refractive index layer 13l, 15l used in each mirror closest to the magneto-optic layer 14 needs to be reduced to compensate for the second bonding layer 12b. Thus if a 15 nm layer of MgO is used then the thickness of the Al₂O₃ will be reduced such that thickness of the Al₂O₃ layer plus the bonding layer 12b is still a quarter of a wavelength thick at the wavelength of operation. The thickness of the low refractive index layer of Al₂O₃ in this situation is calculated using techniques such as Effective Media Approximation (EMA).

Similarly, the thickness of each low refractive index layer 13l, 15l is reduced to take into account when a third bonding layer 12c is used to bond the high refractive index layers 13h, 15h to the low refractive index layers 13l,15l in the mirrors 13, 15.

In one embodiment, the number of layers X used to form the lower mirror 13 made from Al₂O₃ and Ta₂O₅ is 24 and the number of layers Y used to form the upper mirror 15 is 6. The number of layers X is determined such that the reflectivity of the lower mirror 13 exceeds 99%. The number of layers Y to form the upper mirror 15 along with the dielectric materials used in the top mirror is determined to such that the overall reflectivity of the structure is in the range 10% to 40%.

The thickness of the magneto-optic layer 14 is set according to an integral, m, of the following equation:

thickness=m(λ/2n) (Eq. 2)

where:

m=integer (1, 2, 3 . . . z) determined in conjunction with the total reflectivity to provide the required Kerr rotation

n=refractive index of the material; and

λ=wavelength of operation.

In a preferred embodiment, m=3 thus the thickness of a magneto-optic layer 14 made of Bi₂DyFe₄GaO₁₂, having a refractive index of 2.23 at 632 nm, 2.34 at 532 nm and 2.42 at 477 nm is shown in the table below:

| | Approximate |
|---|---|
| Colour @ wavelength | Thickness of Bi₂DyFe₄GaO₁₂ |
| Red @ 632 nm | 425.1 nm |
| Green @ 532 nm | 341.0 nm |
| Blue @ 477 nm | 295.7 nm |

It should be noted that the exemplary structure 10 may also be presented as:

TATATATAMMMMMMATATATATATATATATATATATATAS

where:

T is a quarter wavelength of Ta₂O₅;

A is a quarter wavelength of Al₂O₃;

M is a quarter wavelength of magneto-optic material (i.e. 3 half wavelengths); and

S is the silicon substrate.

It should be appreciated that the thicknesses in the examples above have been calculated assuming that the polarized light 20 enters normally (i.e. at right angles) to the structure 10. A person skilled in the art will appreciate that the thicknesses would need to be adjusted depending on the angle of incidence of the polarized light 20 on the structure 10.

Some advantages over the prior art may be summarised as follows:
1) The bond between the lower mirror and the substrate is improved by using a first bonding layer. Furthermore, the first bonding layer prevents the lower mirror from cracking.
2) The bond between the magneto optic layer and the lower mirror and/or the upper mirror is improved by using a second bonding layer. Furthermore, the second bonding layer prevents diffusion between the magneto optic layer and the lower mirror and the magneto optic layer and the upper mirror.
3) The structure is simplified and thus easier to manufacture compared with the prior art.
4) The use of a third bonding layer between the high and low refractive layers used in the upper mirror and the lower mirror prevents the mirrors from cracking and/or delaminating when annealed. Furthermore, the third bonding layer prevents diffusion between the low and high refractive index layers thus improving the optical performance of the structure.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

Limitations in any patent claims should be interpreted broadly based on the language used in the claims, and such limitations should not be limited to specific examples described herein. In this specification, the terminology “present invention” is used as a reference to one or more aspects within the present disclosure. The terminology “present invention” should not be improperly interpreted as an identification of critical elements, should not be improperly interpreted as applying to all aspects and embodiments, and should not be improperly interpreted as limiting the scope of any patent claims.

1. A structure for rotating a plane of polarization of a polarized visible light signal, including:
a lower mirror bonded to a top of a substrate with a first bonding layer;
a magneto-optic layer disposed on a top of the lower mirror; and
an upper minor disposed on a top of the magneto-optic layer; wherein when the structure is annealed the first bonding layer aids adhesion of the lower mirror to the substrate.

2. The structure of claim 1 wherein the lower mirror and the upper mirror are formed from a number of layers of a high refractive index layer adjoining a low refractive index layer.

3. The structure of claim 2 wherein the high refractive index layer and the low refractive index layer are transparent dielectric materials for use at visible wavelengths.

4. The structure of claim 2 wherein the thickness of the high refractive index layer is λ/4n and the thickness of the low refractive index material is λ/4n, where:
n is the refractive index of the dielectric layer; and
λ is the wavelength of operation.

5. The structure of claim 1 wherein the magneto-optic layer is bonded to the top of the lower mirror with a second bonding layer and wherein the second bonding layer prevents an absorbing layer from forming between the lower mirror and the magneto-optic layer.

6. The structure of claim 1 wherein the upper minor is bonded to the top of the magneto-optic layer with a second bonding layer wherein the second bonding layer prevents an absorbing layer from forming between the upper mirror and the magneto-optic layer.

7. The structure of claim 2 wherein additional third bonding layers are provided between each low refractive index layer and each high refractive index layer used to form the lower minor and the upper mirror.

8. The structure of claim 7 wherein the third bonding layers prevent absorbing layers from forming due to diffusion between the high and low refractive index layers, and prevent the minors from cracking and delaminating when annealed.

9. The structure of claim 2 wherein the low refractive index layer and each bonding layer is chosen from Magnesium Oxide (MgO), Sapphire (AL₂O₃) or Silicon Dioxide (SiO₂).

10. The structure of claim 2 wherein the high refractive index layer is chosen from Tantalum Pentoxide (Ta₂O₅), Gallium Oxide (Ga₂O₃) or Dysprosium Oxide (Dy₂O₃).

11. The structure of claim 2 wherein the high and low refractive index layers crystallize at temperatures above 650° C. to limit dimensional changes which may cause delamination.

12. The structure of claim 1 wherein the magneto-optic layer material is chosen from any one of bismuth iron garnets, such as Bi₂DyFe₄GaO₁₂ or cerium iron garnets such as Ce₂DyFe₄GaO₁₂.

13. The structure of claim 1 wherein the thickness of the magneto-optic layer is an integral number, m, of m(λ/2n) where:
n is the refractive index of the dielectric layer; and
λ is the wavelength of operation.

14. The structure of claim 1 wherein an electronic circuit is formed in or on the substrate.

15. The structure of claim 14 wherein the electronic circuit is protected by a layer of MgO.

16. A method of manufacturing a structure for rotating a plane of polarization of a polarized visible light signal including:
depositing a first bonding layer to a top of a substrate;
depositing a lower minor to a top of the first bonding layer;
depositing a magneto-optic layer to a top of the lower mirror;
depositing an upper mirror to a top the magneto-optic layer; and
annealing the structure;
wherein the first bonding layer aids adhesion of the lower mirror to the substrate.

17. The method of claim 16 wherein the lower mirror and the upper minor are formed from a number of layers of a high refractive index layer adjoining a low refractive index layer.

18. The method of claim 17 wherein the high refractive index layer and the low refractive index layer are transparent dielectric materials for use at visible wavelengths.

19. The method of claim 16 further including the step of depositing a second bonding layer on top of the lower mirror and wherein the second bonding layer prevents an absorbing layer from forming between the lower mirror and the magneto-optic layer.

20. The method of claim 16 further including the step of depositing a second bonding layer on top of the magneto-optic layer wherein the second bonding layer prevents an absorbing layer from forming between the upper mirror and the magneto-optic layer.

21. (canceled)
